(19) United States
(12) Patent Application Publication
(10) Pub. No.: US 2020/0132417 A1
(43) Pub. Date: Apr. 30, 2020

(54) Bulletproof Binder

(71) Applicant: Min Xiang, Bellevue, WA (US)

(72) Inventor: Min Xiang, Bellevue, WA (US)

(21) Appl. No.: 16/174,107

(22) Filed: Oct. 29, 2018

(51) Int. Cl. F41H 1/02; B42F 7/06

(52) U.S. Cl. CPC F41H 1/02; A41D 13/0002; B42F 7/06

(57) ABSTRACT

A bulletproof binder may be operable to quickly transform into a wearable shield adaptable to protect a user against firearms projectiles or other weapons. The bulletproof binder may include a removable shield, front cover, rear cover, or spine, which may be made of bullet-resistant or bulletproof materials. The bulletproof binder may include a bulletproof wrap configured to fit around a user's waist, back, or another body part. The wrap may be an optional choice for users who want extra protection. Fasteners may allow removable shield, or another part of the bulletproof binder, to be removed, rearranged, used as a handheld shield, or used as an extension of a bulletproof vest type of configuration.

### FIELD

This disclosure relates generally to a bulletproof binder.

### BACKGROUND

Gun violence claims thousands of lives in the United States and around the world each year. Victims often have little to no time to protect themselves against an attack. Quick and easy access to protective gear is crucial to saving the lives of potential victims of all ages, sizes, and circumstances.

### SUMMARY

The following presents a simplified summary of the disclosure to provide a basic understanding to the reader. This summary is not an extensive overview of the disclosure, nor does it identify key or critical elements of the claimed subject matter or define its scope. Its sole purpose is to present some concepts disclosed in a simplified form as a precursor to the more detailed description that is later presented.

Potential victims must quickly adapt to evolving risks in a dangerous situation. A person may need to alternate between offensive or defensive survival tactics, depending on an aggressor's actions or location, for example. It is critical that protective gear adapt to changed circumstances. The instant application discloses, among other things, a bulletproof binder operable to quickly transform into a wearable shield adaptable to protect various parts of a user's body against firearms projectiles or other weapons. Its ability to function as a binder may make it more readily accessible to a general population. In addition to providing broader protection for various body parts and body types, the bulletproof binder may provide versatility to adapt to evolving risks in a dangerous situation.

In one implementation, the bulletproof binder may comprise a front cover, rear cover, spine, and front flap. The front cover and rear cover may comprise panels having internally-disposed raised edges that provide structure to the binder and volume for containment of documents or devices. The front cover may removably attach to the rear cover by a fastener. For example, a zipper may run along a perimeter of the front and rear covers, providing a user an option to open, close, or completely detach the front and rear covers. Inner edges of the front and rear covers may typically remain removably fastened when the binder is in an open position.

The spine may comprise a panel disposed parallel to the inner edges of the front and rear covers. The spine may provide structure to the binder and include a handle on its outer surface for easy carrying. An inner surface of the spine may include fasteners, for example, hook-and-loop fasteners, which may receive fasteners disposed near the inner edge of the front cover, allowing the inner edge of the front cover to removably fasten to the spine.

The front flap may comprise a generally U-shaped overlay having two elongated members. When used in a binder configuration, the front flap may extend over an outer surface of the front cover, and its two elongated members may fasten to far edges of the front cover, away from the spine. For example, hook-and-loop fasteners may fasten the elongated members of the front flap to the far edges of the front cover. A space between the front flap and the front cover may provide another location for storage of documents or devices.

In an event of gunfire or other danger, the user may completely unzip the front cover from the rear cover, pull apart the front flap from the front cover, and attach the elongated members of the front flap to the fasteners that extend from the inner edge of the front cover, enabling the front flap to define an opening for the user's head and neck to pass, and thereby forming shoulder straps for a bulletproof vest type configuration. In this example, the rear cover, spine, and front flap may be disposed at a front of the user's body, protecting vital body parts such as a heart, liver, or lungs. The internally-disposed raised edges of the rear cover may provide added coverage by surrounding sides of the user's body. The front cover may be disposed at a back of the user's body, protecting a spinal cord, kidneys, or other body parts. The internally-disposed raised edges of the front cover may also provide added coverage by surrounding the sides of the user's body.

The front cover may also incorporate a bulletproof wrap operable to fold out and fittingly secure around a user's waist or back, providing added protection. The rear cover may also incorporate a removable shield, which may be detached and used to cover the user's head, protecting the brain or other body parts.

In another implementation, the bulletproof binder may comprise a front cover, spine, rear cover, removable shield removably fastened to the rear cover, and fasteners comprising adjustable straps operable to form shoulder straps or waist straps for a bulletproof vest type configuration. When used in a binder configuration, the removable shield may open away from the rear cover, remaining removably fastened at an edge, providing a folder-like storage compartment for documents or devices. A fastener, for example, a buckle or snap button strap, may be disposed on the spine and couple to a fastener on an outer surface of the removable shield, helping to hold the removable shield in place against an outer surface of the rear cover. Concealed fasteners may be disposed in a space between an inner surface of the removable shield and the outer surface of the rear cover. Some or all of these fasteners may remain concealed in a binder configuration.

In an event of gunfire or other danger, a user may pull apart the removable shield from the rear cover, exposing the concealed fasteners. The removable shield may be disposed at a front of a user, and the rear and front covers may be disposed at a back of the user. The concealed fasteners may be coupled to form shoulder or waist straps and may be loosened or tightened to conform to the user's body type and to hold the bulletproof type vest in place.

Any or all parts of the bulletproof binder may be made of a bullet-resistant or bulletproof material, or a material designed protect against projectiles, other weapons, or other dangers. Fasteners may allow any part of the bulletproof binder to be removed, rearranged, used as a handheld shield, or used as an extension of a protective vest, for example. A person skilled in the art will understand that various types of fasteners may be used for any part or accessory of the bulletproof binder, for example, zippers, hook-and-loop fasteners, buckles, straps, belts, or magnets.

### BRIEF DESCRIPTION OF THE DRAWINGS

The present description may be better understood from the following detailed description read in light of the appended drawings, wherein:

FIG. 1 illustrates a perspective exterior view of a bulletproof binder arranged in a closed binder configuration, according to one implementation.

FIG. 2 illustrates a perspective interior view of a bulletproof binder arranged in an open binder configuration, according to one implementation.

FIG. 3 illustrates a rear cover, spine, and front flap of a bulletproof binder, according to one implementation.

FIG. 4 illustrates a perspective interior view of a front cover with a bulletproof wrap of a bulletproof binder, according to one implementation.

FIG. 5 illustrates a top exterior view of a bulletproof binder folded out in an open configuration, according to one implementation.

FIG. 6 illustrates a perspective exploded view of a bulletproof binder in a bulletproof vest type configuration, according to one implementation.

FIG. 7 illustrates a front perspective view of a bulletproof binder in a bulletproof vest type configuration worn by a user, according to one implementation.

FIG. 8 illustrates a perspective exterior view of a bulletproof binder in a closed binder configuration, according to one implementation.

FIG. 9 illustrates a perspective view of a removable shield of a bulletproof binder, according to one implementation.

FIG. 10 illustrates a perspective exploded view of bulletproof binder in a bulletproof vest type configuration, according to one implementation.

FIG. 11 illustrates a perspective view of a bulletproof binder in a bulletproof vest type configuration worn by a user, according to one implementation.

FIG. 12 illustrates a bulletproof binder in a closed binder configuration, according to one implementation.

FIG. 13 illustrates a perspective view of a removable shield as a storage compartment for a binder configuration of a bulletproof binder, according to one implementation.

FIG. 14 illustrates a perspective view of a detached removable shield of a bulletproof binder, according to one implementation.

FIG. 15 illustrates a perspective view of a bulletproof binder in a bulletproof vest type configuration worn by a user, according to one implementation.

FIG. 16 illustrates a perspective view of a bulletproof binder in a bulletproof vest type configuration, according to one implementation.

### DETAILED DESCRIPTION

A more particular description of certain implementations of Bulletproof Binder may be had by references to the implementations shown in the drawings that form a part of this specification, in which like numerals represent like objects.

The illustrated operations in the description show certain events occurring in a certain order. One skilled in the art will recognize that certain operations may be performed in a different order, modified or removed. Moreover, steps may be added to the described logic and still conform to the described implementations.

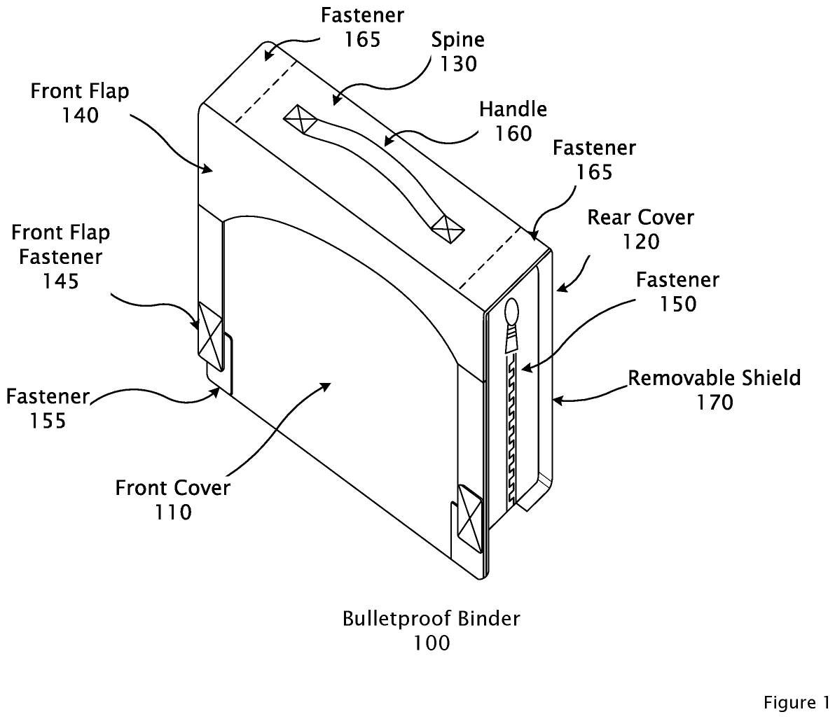

FIG. 1 illustrates a perspective exterior view of Bulletproof Binder 100 arranged in a closed binder configuration. In one implementation, Bulletproof Binder 100 may comprise a Front Cover 110, Rear Cover 120, Spine 130, and Front Flap 140. Front Cover 110 and Rear Cover 120 may comprise panels having internally-disposed raised edges that provide structure to the binder and volume for containment of documents or devices. Front Cover 110 may removably attach to Rear Cover 120 by a Fastener 150. Fastener 150 may comprise a zipper that runs along a perimeter of Front Cover 110 and Rear Cover 120. Fastener 150 may help secure stored items while providing a user an option to open, close, or completely detach Front Cover 110 and Rear Cover 120.

Spine 130 may comprise a panel disposed parallel to the inner edges of Front Cover 110 and Rear Cover 120. Spine 130 may provide structure to the binder and include a Handle 160 on its outer surface for easy carrying. An inner surface of Spine 130 may include Fastener 165s, for example, hook-and-loop fasteners, which may receive fasteners disposed near the inner edge of Front Cover 110, allowing the inner edge of Front Cover 110 to removably fasten to Spine 130.

Front Flap 140 may comprise a generally U-shaped overlay having two elongated members. Front Flap Fastener 145s, for example, hook-and-loop fasteners, may be disposed on ends of the two elongated members. When used in a binder configuration, Front Flap 140 may extend over an outer surface of Front Cover 110, and Front Flap Fastener 145s may fasten to Fastener 155s on far edges of Front Cover 110, away from Spine 130. A space between Front Flap 140 and Front Cover 1a0 may provide another location for storage of documents or devices.

In an event of gunfire or other danger, the user may unzip Fastener 150 to detach Front Cover 110 from Rear Cover 120, pull apart Front Flap 140 from Front Cover 110, and attach Front Flap Fastener 145s to the fasteners disposed near the inner edge of Front Cover 110, enabling Front Flap 140 to define an opening for the user's head and neck to pass, and forming shoulder straps for a bulletproof vest type configuration. Rear Cover 120, Spine 130, and Front Flap 140 may be positioned at a front of the user's body, protecting vital body parts such as a heart, liver, or lungs. The internally-disposed raised edges of Rear Cover 120 may provide added coverage by surrounding sides of the user's body. Front Cover 110 may be positioned at a back of the user's body, protecting a spinal cord, kidneys, or other body parts. The internally-disposed raised edges of Front Cover 110 may also provide added coverage by surrounding the sides of the user's body.

Front Cover 110 may also incorporate a bulletproof wrap operable to fold out and fittingly secure around a user's waist or back, providing added protection. Rear Cover 120 may also incorporate a Removable Shield 170, which may be detached and used to cover the user's head, protecting the brain, or other body parts.

Various protective materials may be used for a Bulletproof Binder 100 to protect a user against firearms projectiles or other weapons or dangers. For example, it may include bullet-resistant or bullet-proof materials comprising plates made of metal or ceramic bonded to fiberglass. In another implementation, it may include panels made of layers of tightly-woven material, for example, Kevlar®.

A person skilled in the art will understand that fasteners, such as Front Flap Fastener 145, Fastener 155, or Fastener 150, may comprise various methods of connection, for example, hook-and-loop fasteners, buckles, snap fasteners, clip-on hooks, magnets, adjustable elastic straps, buttons, clips, ties, belts, nylon webbing or hooks, among many others. Fastener positions and configurations may vary according to a type of fastener used. For example, length-adjustable elastic straps may be sewn onto the binder, or a snap fastener may be disposed in a different position than a clip button in another implementation.

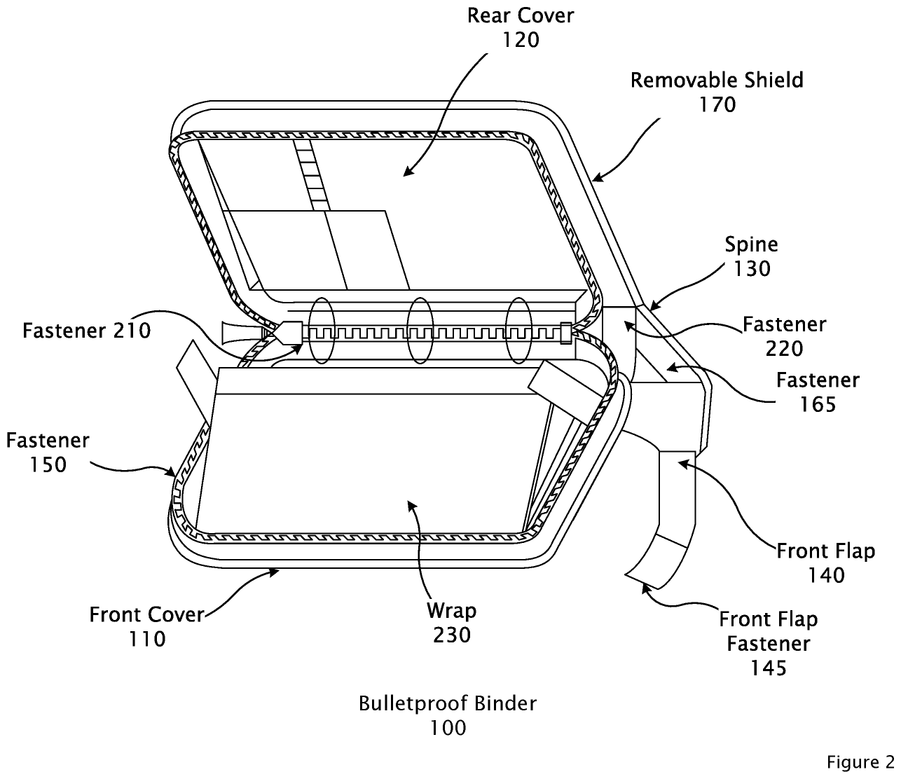

FIG. 2 illustrates a perspective interior view of a Bulletproof Binder 100 arranged in an open binder configuration, according to one implementation. Fastener 210s may comprise binder clips or other types of fasteners disposed on or in Bulletproof Binder 100 to hold documents or devices. Front Cover 110 and Rear Cover 120 may comprise panels having internally-disposed raised edges that provide structure to the binder and volume for containment of documents or devices. Front Cover 110 may removably attach to Rear Cover 120 by Fastener 150, which may comprise a zipper that runs along a perimeter of Front Cover 110 and Rear Cover 120, providing a user an option to open, close, or completely detach Front Cover 110 and Rear Cover 120. Inner edges of the front and rear covers may typically remain removably fastened when the binder is in an open position.

Spine 130 may comprise a panel disposed parallel to the inner edges of Front Cover 110 and Rear Cover 120. An inner surface of Spine 130 may include Fastener 165s, for example, hook-and-loop fasteners, that may receive Fastener 220s disposed near the inner edge of Front Cover 110, allowing the inner edge of Front Cover 110 to removably fasten to Spine 130.

Front Flap 140 may comprise a generally U-shaped overlay having two elongated members. When used in a binder configuration, Front Flap 140 may extend over an outer surface of Front Cover 110, and Front Flap Fastener 145s may fasten to far edges of Front Cover 110, away from Spine 130.

Front Cover 110 may incorporate a Wrap 230, which may be operable to fold out and fittingly secure around a user's waist or back, or another body part, providing added protection. Rear Cover 120 may incorporate Removable Shield 170, which may be detached and used to cover the user's head, protecting the brain, or other body parts, depending on a nature of a risk faced or protection needed.

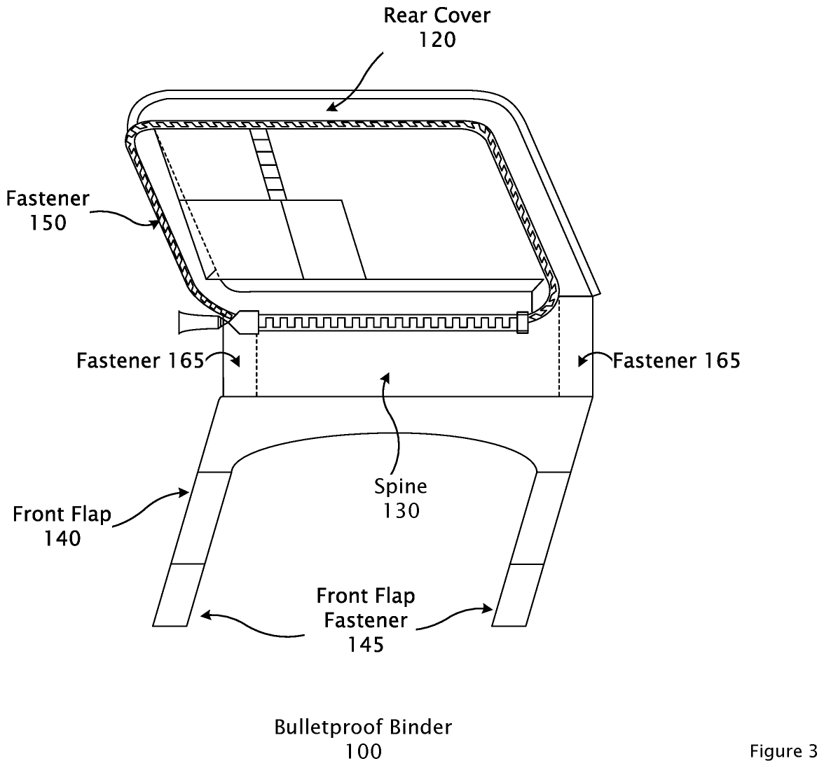

FIG. 3 illustrates a rear cover, spine, and front flap of a Bulletproof Binder 100. In one implementation, Rear Cover 120, Spine 130, and Front Flap 140 may comprise one integral piece. Rear Cover 120 may detach from the front cover by completely unzipping Fastener 150. Spine 130 may detach from the front cover by detaching Fastener 165s from fasteners disposed near the inner edge of the front cover. Front Flap 140 may detach from the front cover by pulling apart Front Flap Fastener 145s from fasteners on far outer edges of the front cover, for example.

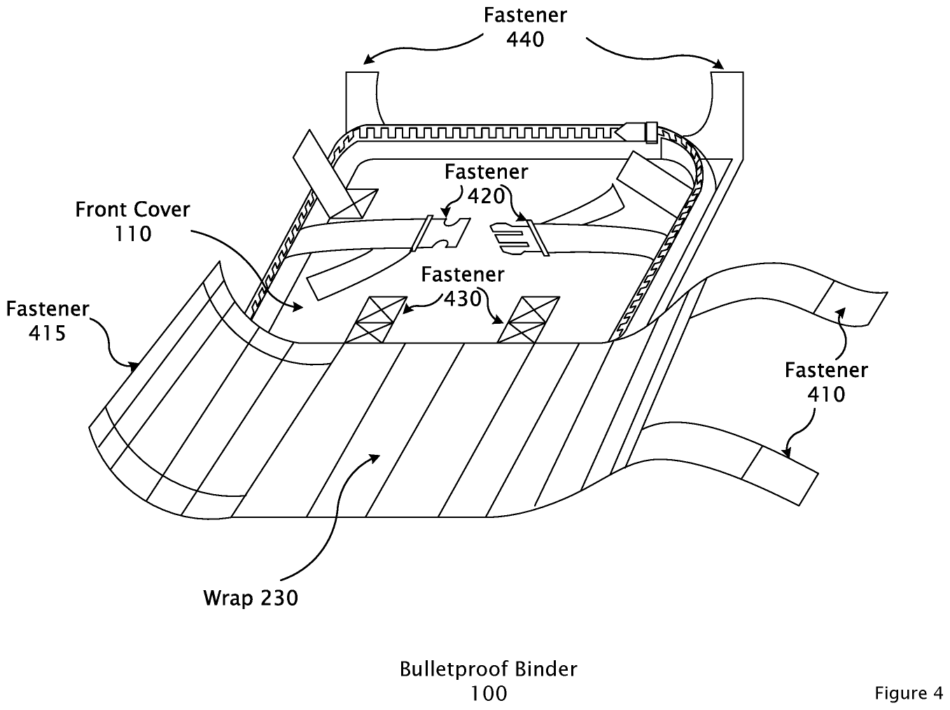

FIG. 4 illustrates a perspective interior view of a front cover with a bulletproof wrap of Bulletproof Binder 100. In one implementation, Front Cover 110 may incorporate a Wrap 230, which may comprise a bulletproof shield operable to fit around a user's waist, back, or another body part, depending on a nature of a risk involved or protection needed. In a binder configuration, Wrap 230 may remain stored against an inner surface Front Cover 110. When a bulletproof type vest configuration is desired, Wrap 230 may fold out or be attached, providing an option for users needing for extra protection. Fasteners, for example, Fastener 410s or Fastener 415, may couple to secure Wrap 230 around the user's waist, back, or another body part. Fastener 420s may comprise adjustable straps with buckles or another fastener type to wrap around a user's chest. Fastener 430s may extend from and be removably attached to Wrap 230. Fastener 430s may allow coupling of other components or extendable pieces.

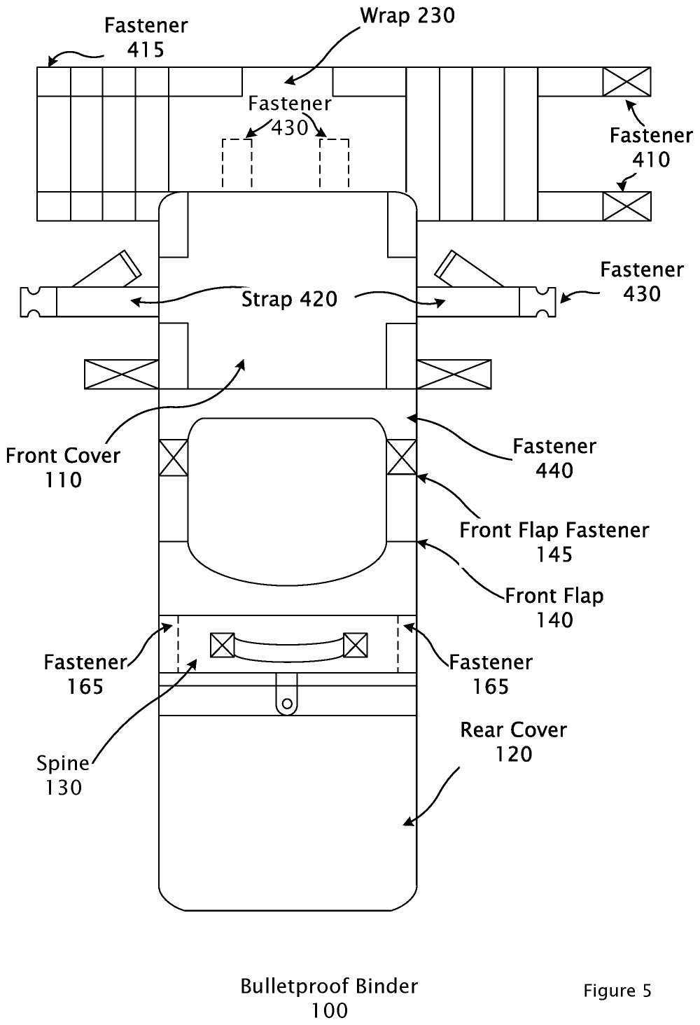

FIG. 5 illustrates a top exterior view of a Bulletproof Binder 100 folded out in an open configuration, according to one implementation. Front Flap 140 may couple to Fastener 450 to define an opening for a user's head and neck to pass and provide shoulder straps for a bulletproof vest type configuration. Wrap 230 may comprise a bulletproof shield that may fold out or be attached by Fastener 410s or Fastener 415s, for example. Wrap 230 may wrap around a user's waist, back, or another body part. Fastener 420s may wrap around a user's chest or abdomen, for example, providing a secure and comfortable fit.

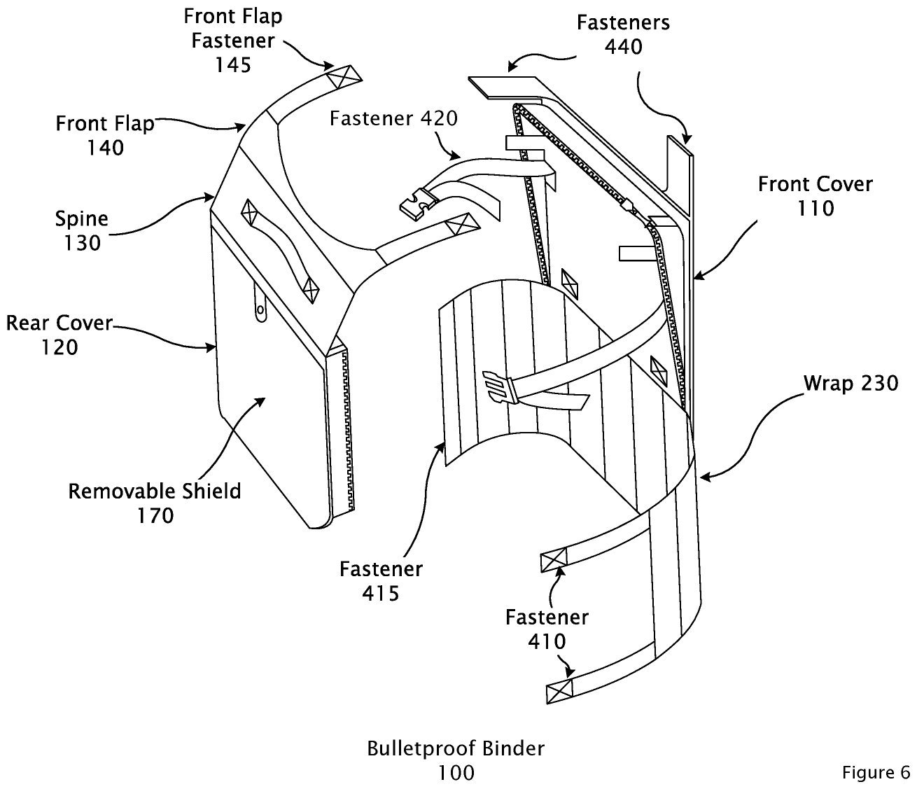

FIG. 6 illustrates a perspective exploded view Bulletproof Binder 100 in a bulletproof vest type configuration, according to one implementation. When worn by a user, Rear Cover 120, Spine 130, and Front Flap 140 may cover a front part of a user's body, and Front Cover 110 may cover a back side of the user's body, or vice-versa. Removable Shield 170 may remain incorporated in Rear Cover 120 or be detached to use as a handheld shield. Front Flap Fastener 145 may couple to Fasteners 440 to provide shoulder straps, and raised edges of Front Cover 110 and Rear Cover 120 may provide additional coverage over a user's sides. Wrap 230 may fold down from Front Cover 110 to wrap around a user's waist, back, or another body part. Fastener 410s and Fastener 415s may secure Wrap 230 to the user. Fastener 420s may comprise adjustable straps with buckles or another fastener type to wrap around a user's chest.

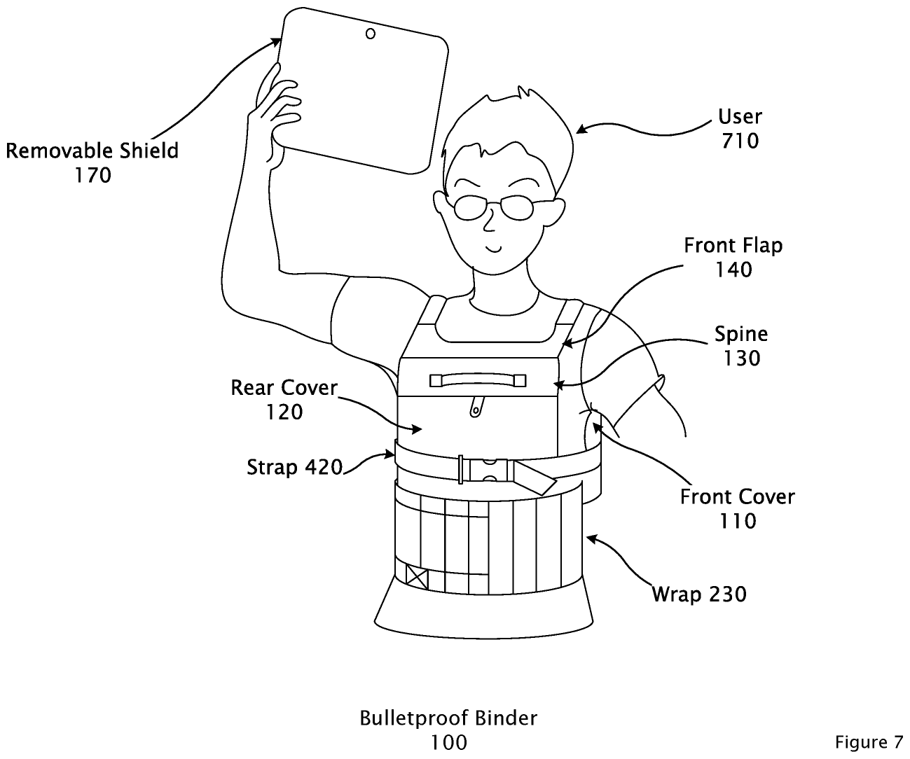

FIG. 7 illustrates a front perspective view of a Bulletproof Binder 100 in a bulletproof vest type configuration worn by a User 710. Rear Cover 120, Spine 130, and Front Flap 140 may protect a front, and Front Cover 110 may protect a back of User 710. Front Flap 140 may provide shoulder straps for the bulletproof vest type configuration. Fastener 420s my wrap around User 710's chest to secure Bulletproof Binder 100 to User 710. Removable Shield 170 may detach from Rear Cover 120 to be used as a handheld shield to protect any part of User 710's body. Wrap 230 may comprise a bulletproof shield operable to wrap around a user's waist, back, or another body part.

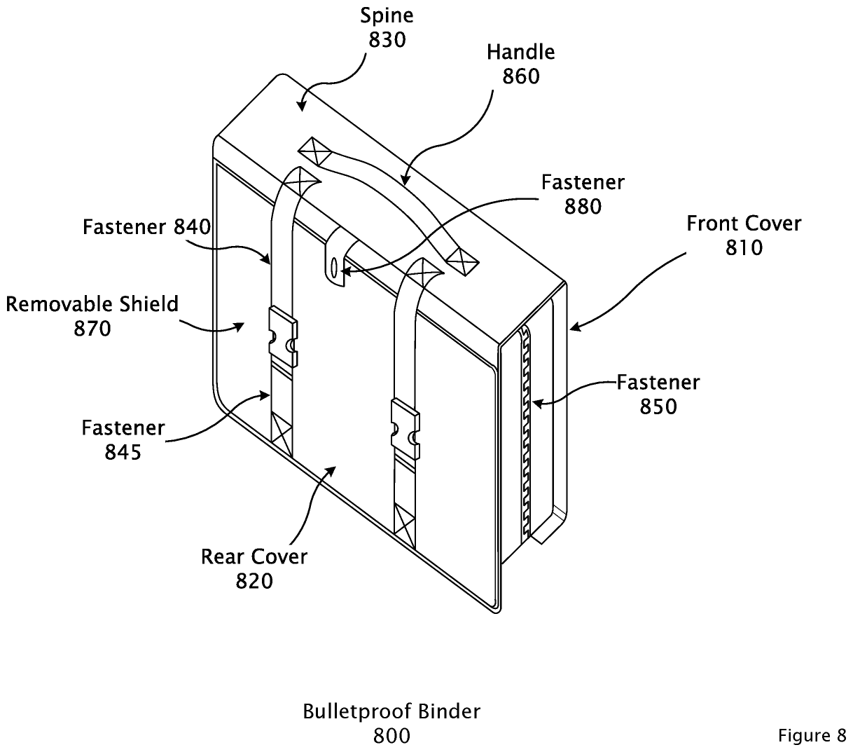

FIG. 8 illustrates a perspective exterior view of Bulletproof Binder 800 in a closed binder configuration, according to one implementation. Bulletproof Binder 800 may comprise Front Cover 810, Rear Cover 820, Spine 830, a Removable Shield 870 removably fastened to Rear Cover 820, and fasteners. Fastener 840 and Fastener 845 may comprise adjustable straps with buckles or another fastener type. In a binder configuration, Fastener 840s may couple to Fastener 845s to help secure Removable Shield 870 against an outer surface of Rear Cover 820. Another fastener, for example, Fastener 880, may be disposed on Spine 830 and couple to a fastener on an outer surface of Removable Shield 870 to provide another option for holding Removable Shield 870 in place.

Handle 860 may allow for easy carrying. Fastener 850, a zipper, for example, may help secure stored items while providing a user an option to open, close, or completely detach Rear Cover 820 from Front Cover 810.

In a bulletproof vest type configuration, a user may detach Fastener 880 from Removable Shield 870 and detach Fastener 840s from Fastener 845s. Concealed fasteners may be disposed in a space between an inner surface of the removable shield and the outer surface of the rear cover. Some or all of these fasteners may remain concealed in a binder configuration. Fastener 840s may couple to the concealed fasteners forming shoulder straps for the bulletproof type vest configuration.

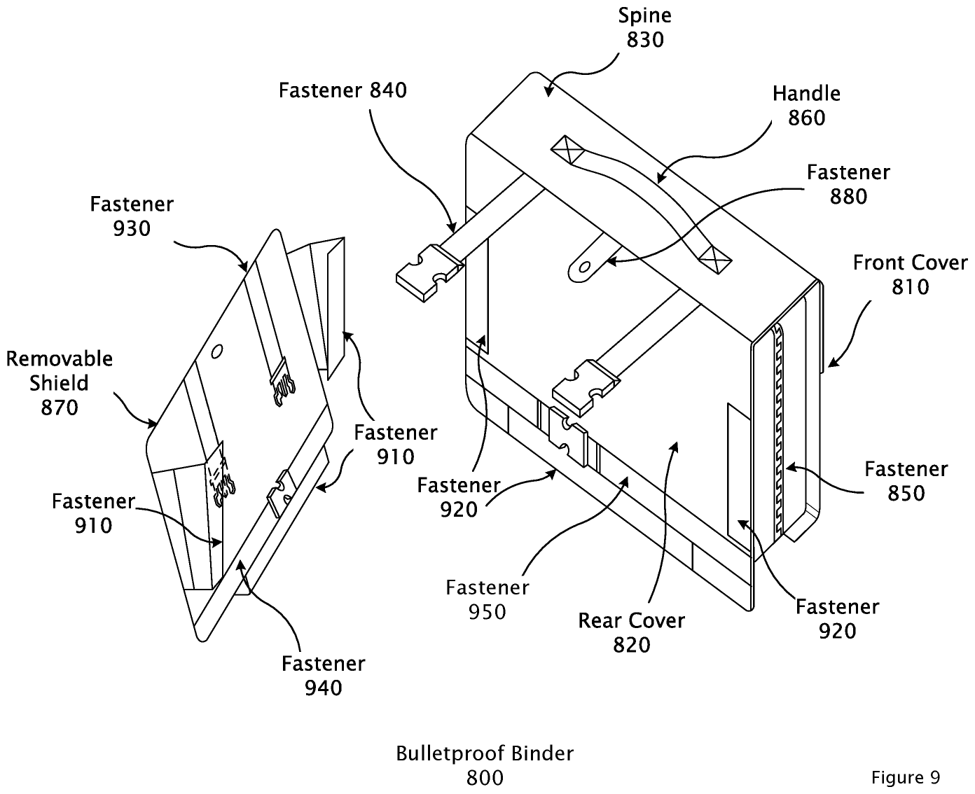

FIG. 9 illustrates a perspective view of a Removable Shield 870 of Bulletproof Binder 800, according to one implementation. A user may detach Removable Shield 870 from Rear Cover 820 by unfastening Fastener 880 and Fastener 840 from fasteners disposed on an outer surface of Removable Shield 870. Removable Shield 870 may also be detached by unfastening Fasteners 910, for example, hook-and-loop fasteners, which had coupled to Fastener 920s disposed on an outer surface of Rear Cover 820. Detaching Removable Shield 870 may expose concealed fasteners, such as Fastener 910s and Fastener 920s, as well as Fastener 930s, Fastener 940s, disposed on an inner surface of Removable Shield 870, and Fastener 950s, disposed on an outer surface of Rear Cover 820. Removable Shield 870 may be used as a handheld shield or as a part of a bulletproof vest type of configuration.

A person skilled in the art will understand that fasteners may comprise various methods of connection, for example, hook-and-loop fasteners, buckles, snap fasteners, clip-on hooks, magnets, adjustable elastic straps, buttons, clips, ties, belts, nylon webbing or hooks, among many other fastener types. Fastener positions and configurations may vary according to a type of fastener used. For example, length-adjustable elastic straps may be sewn onto the binder, or a snap fastener may be disposed in a different position than a clip button in another implementation.

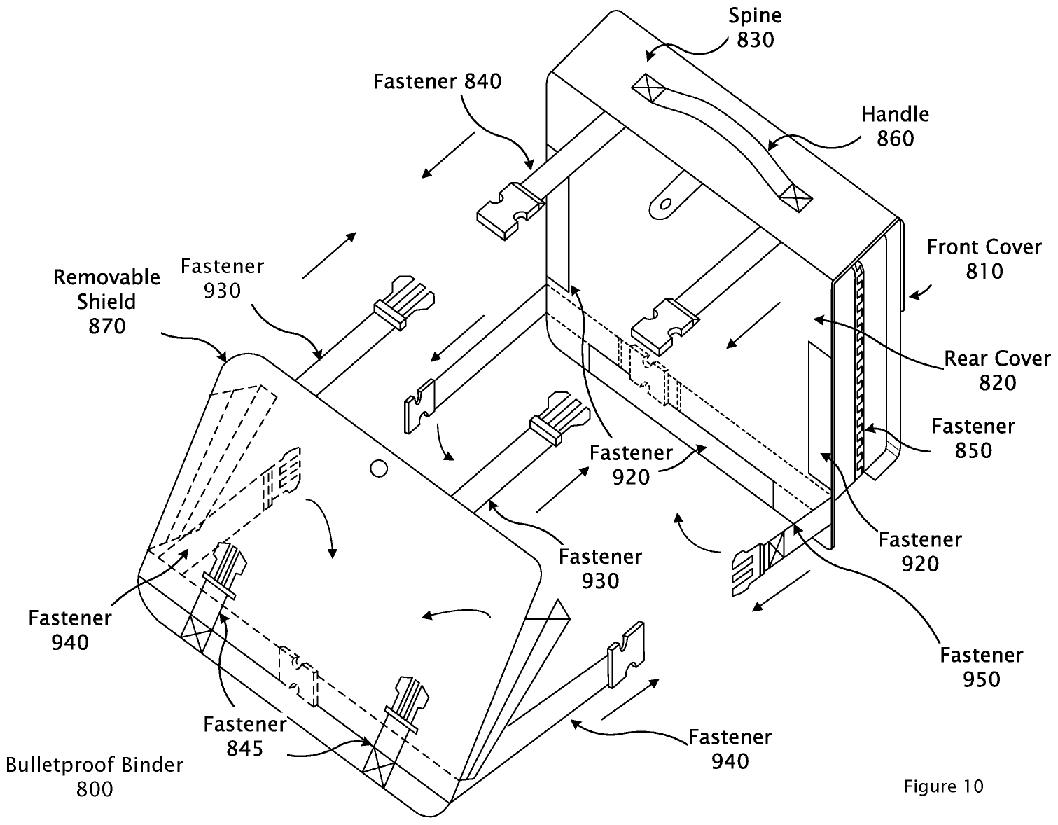

FIG. 10 illustrates a perspective exploded view of Bulletproof Binder 800 in a bulletproof vest type configuration, according to one implementation. Illustrative arrows may show a direction in which fasteners may connect. For example, Fasteners 930s may couple to Fastener 840s, securing Removable Shield 870 to Rear Cover 820 and forming shoulder straps. Fastener 940s may couple to Fastener 950s, securing Removable Shield 870 to Rear Cover 820 and forming side straps.

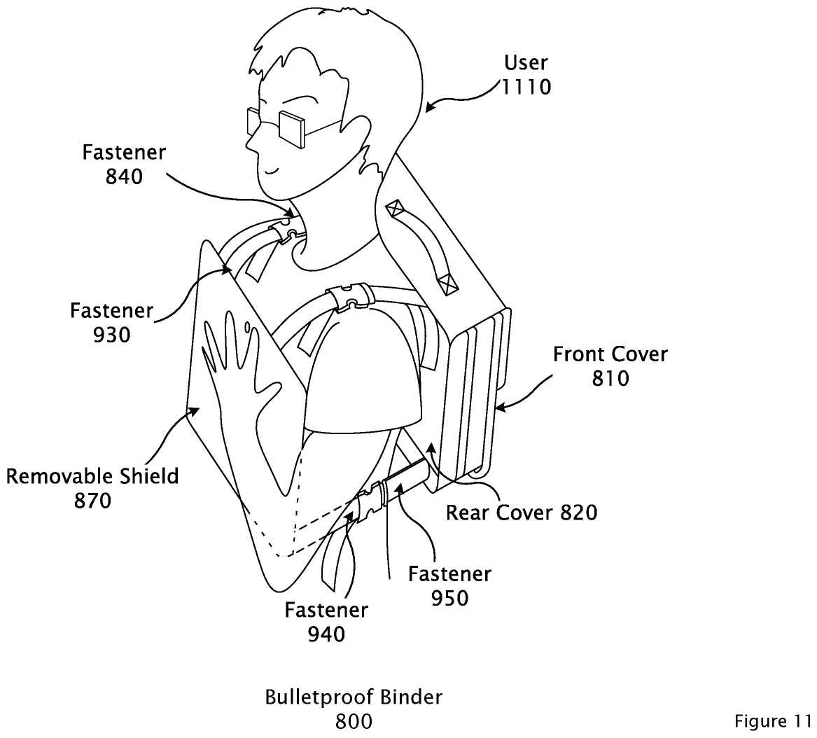

FIG. 11 perspective view of a Bulletproof Binder 800 in a bulletproof vest type configuration worn by a User 1110, according to one implementation. User 1110 may couple Fastener 930 and Fastener 840s, forming shoulder straps, and couple Fastener 940s and Fasteners 950, forming side straps, which may be disposed below armpits or near a waist. Removable Shield 870 may cover a front side of User 1110 while Rear Cover 820 and Front Cover 810 cover the user's back side, for example.

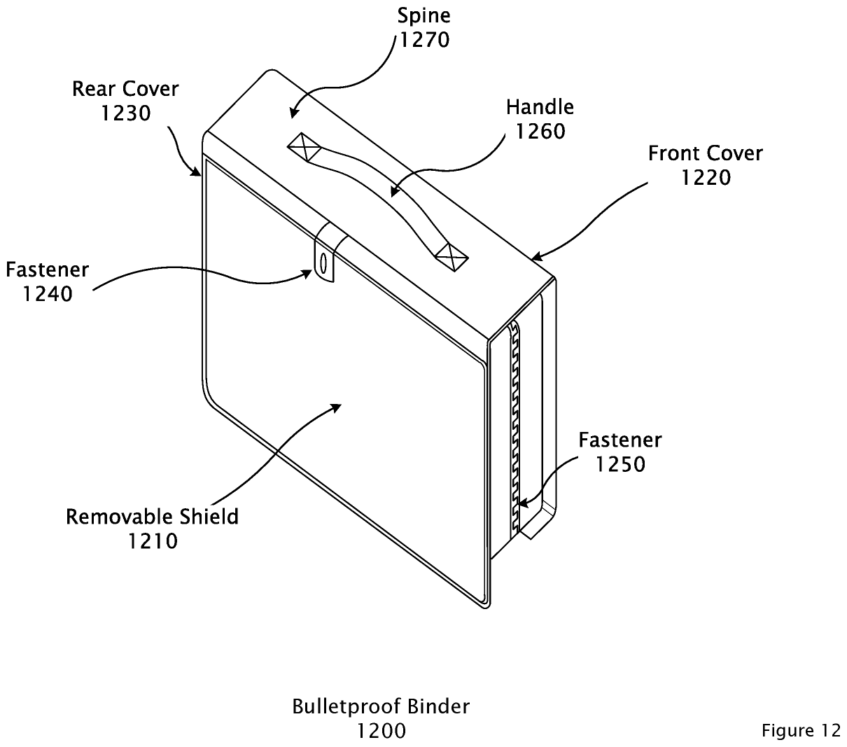

FIG. 12 illustrates a perspective view of Bulletproof Binder 1200 in a closed binder configuration, according to one implementation. Handle 1260 may allow for easy carrying while Fastener 1250, a zipper, for example, may help secure stored items. Bulletproof Binder 1200 may have one or more bulletproof shields, for example, Removable Shield 1210, Rear Cover 1230, Front Cover 1220, or Spine 1270. Spine 1270 may incorporate straps and provide structure to Bulletproof Binder 800. Fastener 1240, for example, a button or lock, may secure contents while the binder is in a closed configuration or may help secure Removable Shield 1210 to Rear Cover 1230.

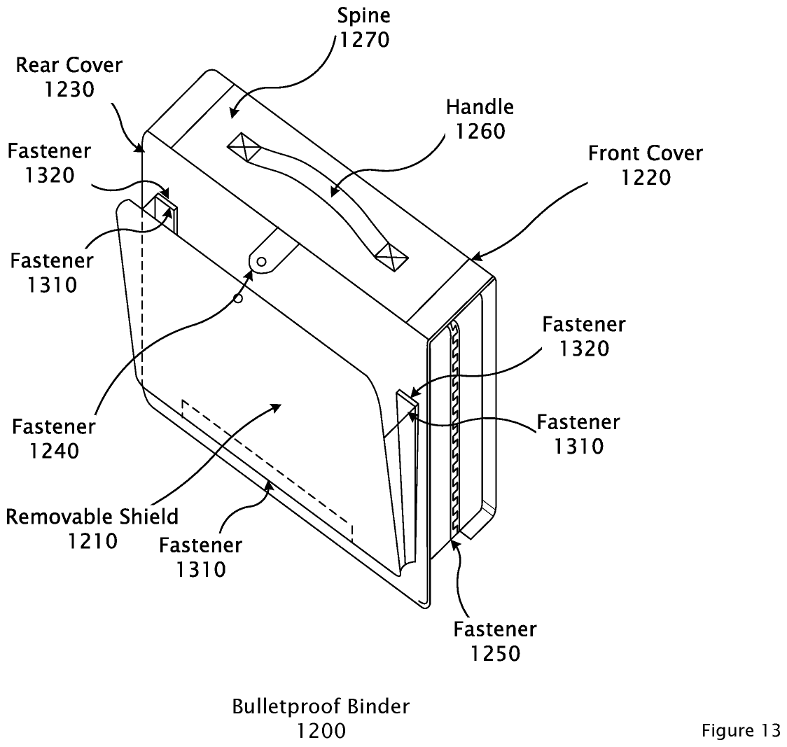

FIG. 13 illustrates a perspective view of a Removable Shield 1210 as a storage compartment for a binder configuration of Bulletproof Binder 1200. Removable Shield 1210 may attach to Rear Cover 1230 by coupling Fastener 1310s, disposed on an inner surface of Removable Shield 1210, to Fastener 1320s, disposed on an outer surface of Rear Cover 1230. When used in a binder configuration, a user may detach Fastener 1240 open a storage compartment provided by Removable Shield 1210. Removable Shield 1210 may open away from Rear Cover 1230, remaining removably fastened at an edge, providing a folder-like storage compartment for documents or devices.

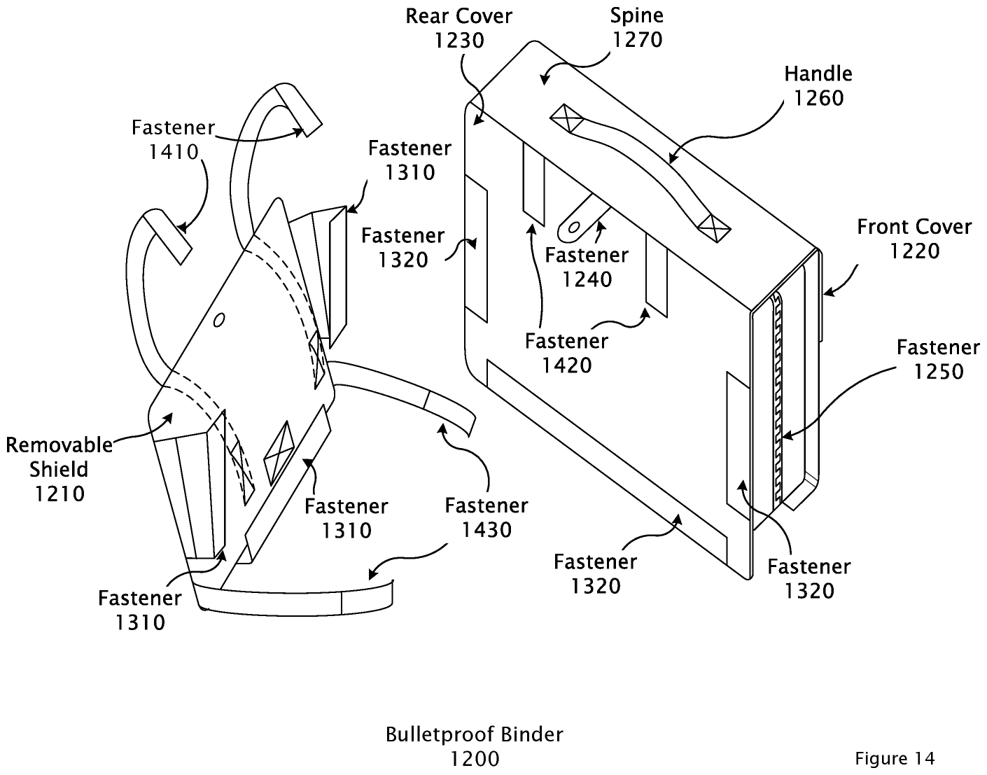

FIG. 14 illustrates a perspective view of a detached Removable Shield 1210 of a Bulletproof Binder 1200, according to one implementation. In an event of gunfire or other danger, a user may pull apart Removable Shield 1210 from Rear Cover 1230, exposing concealed fasteners. For example, Fastener 1410s may comprise adjustable straps that may fasten to Fastener 1420s to form shoulder straps for a bulletproof type vest configuration. Fastener 1430s may comprise adjustable straps that may couple to Fastener 1320s to form waist straps.

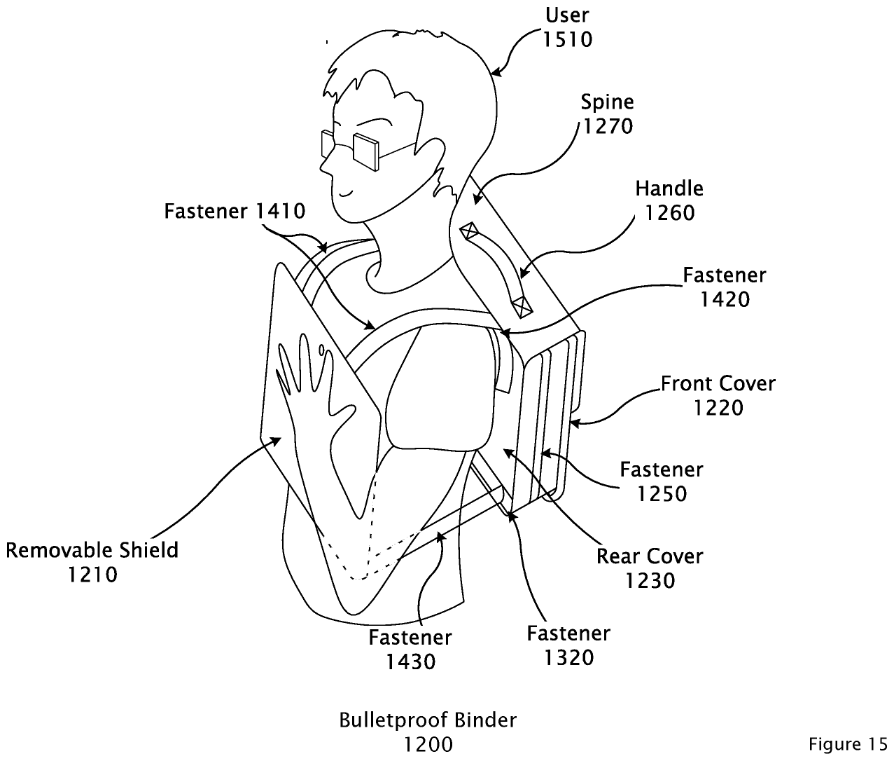

FIG. 15 illustrates a perspective view of a Bulletproof Binder 1200 in a bulletproof vest type configuration worn by a User 1510. Bulletproof Binder 1200 may secure to User 1510's body, protecting vital organs from firearms projectiles or other dangers. Removable Shield 1210 may be placed at a front of a User 1510, while Rear Cover 1230 and Front Cover 1220 may be disposed at a back of User 1510. Fastener 1410s may couple to Fastener 1420s, providing shoulder straps. Fastener 1430s may couple to Fastener 1320, providing side straps.

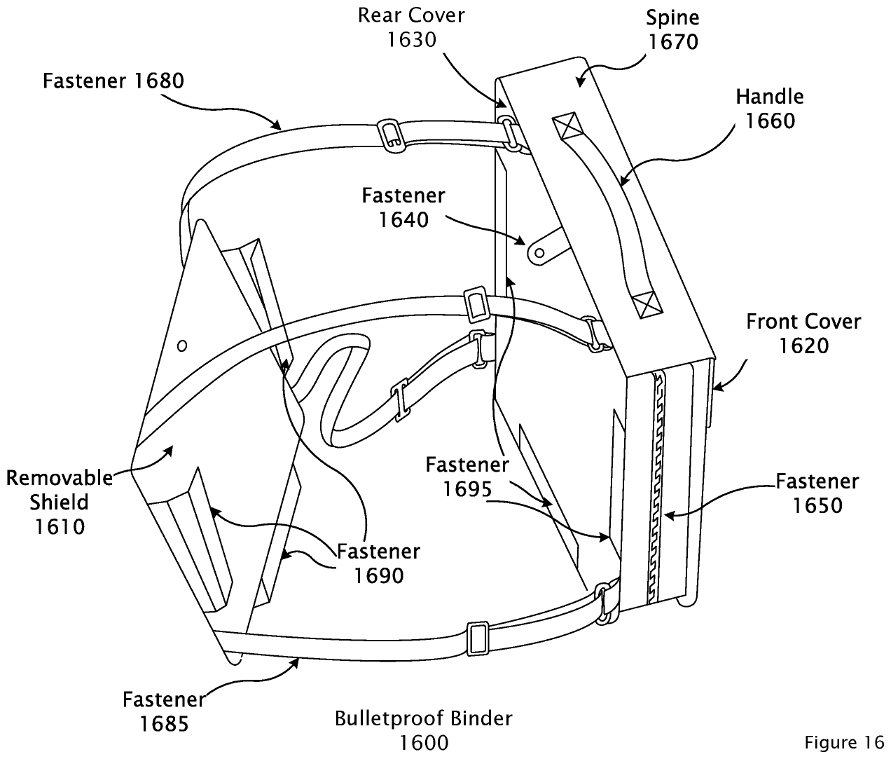

FIG. 16 illustrates a perspective view of a Bulletproof Binder 1600 in a bulletproof vest type configuration, according to one implementation. Fastener 1680s and Fastener 1685s may comprise adjustable straps that may be removably or permanently attached, for example, sewn, to Binder 1600. Fastener 1680s and Fastener 1685s may include strap adjusters, loops, or other devices. A user may detach Removable Shield 1610 from Rear Cover 1630 by detaching Fastener 1690s from Fastener 1695s. Fastener 1670s and Fastener 1680s may comprise hook-and-loop fasteners or another fastener type. Removable Shield 1610 may be used as part of a handheld shield or as a protective vest. Removable Shield 1610 may be removably attached to Spine 1670 by Fastener 1640, for example. For a bulletproof type vest configuration, a user may pass through openings defined by Fastener 1680s and Fastener 1685s, positioning Removable Shield 1610 at a front of the user's body. Remaining components of Bulletproof Binder 1600, which may include Rear Cover 1630, Front Cover 1620, Spine 1670, Handle 1660, and Fastener 1650, may be positioned at a back of the user's body. Fastener 1680s may rest on the user's shoulders and Fastener 1685s may be disposed below the user's armpits or near a waist, and may be adjusted for a secure and comfortable fit.

While the detailed description above has been expressed in terms of specific examples, those skilled in the art will appreciate that many other configurations could be used. Accordingly, it will be appreciated that various equivalent modifications of the above-described implementations may be made without departing from the spirit and scope of the invention.

1. A binder, comprising:
a front cover;
a rear cover;
a spine;
a front flap;
wherein at least a portion of the binder comprises a material selected from the list containing bulletproof material, bullet-resistant material, metal plates, ceramic bonded to fiberglass, and panels made of layers of tightly-woven material; and
a plurality of fasteners, the fasteners operable to secure the binder to a user's body.

2. The binder of claim 1, wherein the front cover comprises a wrap, the wrap operable to fold out and fittingly secure around a user's body.

3. The binder of claim 1, wherein the rear cover comprises a removable shield.

4. The binder of claim 1, wherein the front cover and rear cover comprise panels having internally-disposed raised edges.

5. The binder of claim 1, wherein the front cover removably attaches to the rear cover by a fastener.

6. The binder of claim 1, wherein the spine includes a handle.

7. The binder of claim 1, wherein a fastener is disposed on the front flap, the fastener operable to couple to a fastener disposed near an inner edge of the front cover.

8. The binder of claim 7, wherein the coupling of the fastener disposed on the front flap to the fastener disposed near the inner edge of the front cover defines an opening for a user's head or neck to pass or provides shoulder straps for a bulletproof vest type configuration.

9. The binder of claim 1, wherein an inner surface of the spine includes a fastener operable to receive fasteners disposed near the inner edge of the front cover, allowing the inner edge of the front cover to removably fasten to the spine.

10. The binder of claim 1, wherein the front flap comprises a generally U-shaped overlay having two elongated members.

11. The binder of claim 10, wherein fasteners are disposed on ends of the two elongated members of the front flap.

12. The binder of claim 10, wherein the front flap is operable to extend over an outer surface of the front cover, and elongated members of the front flap are operable to fasten on far edges of the front cover, away from the spine.
